(19) United States
(12) Patent Application Publication
(10) Pub. No.: US 2026/0002911 A1
(43) Pub. Date: Jan. 1, 2026

(54) SYSTEMS, DEVICES, AND METHODS FOR HIGH-THROUGHPUT NON-CONTACT CHARACTERIZATION OF MATERIALS VIA VIBRATIONAL SIGNATURES

(71) Applicants: MASSACHUSETTS INSTITUTE OF TECHNOLOGY, Cambridge, MA (US); CENTRE NATIONAL DE LA RECHERCHE SCIENTIFIQUE, Paris (FR)

(72) Inventors: Yun KAI, Cambridge, MA (US); Thomas PEZERIL, Cambridge, MA (US); Carlos M. PORTELA, Cambridge, MA (US)

(21) Appl. No.: 19/117,030

(22) PCT Filed: Oct. 5, 2023
(86) PCT No.: PCT/US2023/076047

§ 371 Date: Mar. 28, 2025

Related U.S. Application Data
(60) Provisional application No. 63/380,059, filed on Oct. 18, 2022.

(51) Int. Cl. G01N 29/24; B33Y 30/00; B33Y 50/02; G01N 29/12

(52) U.S. Cl. CPC G01N 29/2418; B33Y 30/00; B33Y 50/02; G01N 29/12

(57) ABSTRACT

Systems, devices, and methods for measuring the dynamic properties of metamaterials at the microscale are provided. For example, laser-induced resonant acoustic spectroscopy (LIRAS) can be used as a non-destructive and/or non-contact optical framework within a material of interest to measure photoacoustic excitation of elastic waves. The system can include a pulsed-laser-based mechanical characterization technique that emits lasers at the sample of interest from various directions to demonstrate a high-throughput non-contact framework that employs MHz-wave propagation signatures to create a vibrational response. The vibrational response of the sample of interest can be used to extract dynamic mechanical properties thereof, such as omnidirectional elastic information, damping properties, and defect quantification. In some embodiments, the LIRAS technique can be employed in a characterization module within an additive manufacturing system to measure parameters of printed parts.

### CROSS REFERENCE TO RELATED APPLICATION

The present disclosure claims priority to and the benefit of U.S. Provisional Application No. 63/380,059, entitled “High-Throughput Non-Contact Nanomechanical Characterization via Vibrational Signatures,” filed on Oct. 18, 2022, and which is incorporated by reference herein in its entirety.

### FIELD

The present disclosure relates to systems, devices, and methods for non-contact characterization of a dynamic response of materials (e.g., metamaterials) at the microscale, and more particularly relates to leveraging high-throughput characterization by using photoacoustic excitation of materials to convert vibrational signatures of created elastic waves to dynamic elastic properties and wave propagation measurements thereof.

### BACKGROUND

Advanced materials at the nano- to micro-scale, such as mechanical metamaterials, i.e., materials with properties that are dictated by nano- or microscopic three-dimensional (3D) building blocks instead of the properties of the constituent material, have become an active research field due, at least in part, to their ability to attain previously unreachable combinations of properties. These materials have attained extreme mechanical properties that, in some cases, approach theoretical limits of stiffness and strength, achieve high mechanical resilience or energy absorption, or even negative Poisson's ratios. For example, their design principles can target frequency-dependent properties and resilience upon high-strain-rate deformation, making them versatile materials for applications in lightweight impact resistance, acoustic waveguiding, or vibration damping.

Mechanical metamaterials at the microscale can exhibit exotic static properties owing, at least in part, to their engineered building blocks, but their dynamic properties have remained significantly less explored. For example, widespread knowledge of these nano- and micro-scale metamaterials has remained limited to quasi-static responses, which are far from several application-relevant dynamic conditions where these materials can provide superior performance. To the extent there have been attempts to characterize these materials, the attempts, at best, are in limited dynamic regimes ranging from underwater ultrasound propagation to supersonic impact, and further, involve data acquisition that is undesirably slow and time-consuming. Specifically, accessing dynamic properties of these materials at small scales has remained a challenge due at least to low-throughput and destructive characterization, as well as a lack of existing testing protocols. While interest in dynamic properties of metamaterials has outpaced current characterization routes, recent studies have shown promising advancements in some dynamic regimes, from piezo-excitation to underwater ultrasound propagation, elucidating routes to induce polarization and form band gaps for mechanical waves. However, these methods have been limited to extracting wave-propagation properties, while extraction of dynamic elastic properties remains challenging. Their contact-based and fluid-coupled measurements pose limitations towards performing high-throughput characterization, which severely limits understanding of metamaterials under dynamic conditions.

Microscale metamaterial properties have historically been extracted from stress-strain curves captured by nanoindentation tools, which face a trade-off between deformation amplitude and increases in strain rate, and/or split-Hopkinson pressure bars. Nanoindentation has been applied to determine static elastic constants by measuring the stress-strain relation of the sample. However, dynamic regimes may correspond to different elastic constants. Moreover, nanoindentation has not been successfully modified to investigate the dynamic response of metamaterials, partially due to complications in the contact-measurement mode. Further, there are technical challenges to increase the data-reading rate with the increasing strain-rate.

Conventional measurement techniques suffer from several shortcomings. For example, dynamic mechanical properties of microscale metamaterials and full elasticity-tensor approximations have only been possible using dynamic numerical frameworks or computational homogenization approaches, respectively. These limitations have left a void in understanding anisotropy, damping properties, and wave propagation in advanced metamaterials. While dynamic characterization techniques at large scales like the split-Hopkinson pressure bar method, which may be an alternative to nanoindentation, have served as a proxy to understand microscopic metamaterial behavior, the contact-based, destructive nature of these methods results in low-throughput, one-time measurements with considerable variability, and a possible negative effect or impact on the material being measured resulting from the contact to make the measurements. Further, bars with different materials and dimensions are typically individually chosen for different samples, risking the accuracy of the measurements. With advances in data-driven design tools for metamaterials, experimental throughput has failed to keep up with vast design parameters spaces, particularly in dynamic regimes.

Accordingly, there is a need for high-throughput systems, methods, and devices for uncovering dynamic responses of materials, such as metamaterials, at small scales to enable characterization and data collection of properties of materials to expand the scope of their multifunctional applications.

### SUMMARY

The present disclosure provides for systems, devices, and methods for performing high-throughput characterization of the dynamic response of materials, such as metamaterials, at the microscale. Characterization can include high-strain rate dynamic measurements to assess various properties of the materials. Characterization can be performed by a non-destructive and non-contact optical framework that can convert vibrational signatures to dynamic elastic properties and/or wave propagation measurements. In some embodiments, photoacoustic excitation of the materials can be leveraged to exhibit low-amplitude elastic deformation within the materials over short timescales to extract properties such as precise damping-property measurements, omnidirectional stiffness, and/or defect quantification within complex microscale samples. Photoacoustic excitation can occur by emitting various types of waves at samples of the material to measure these properties. The system, devices, and methods of the present embodiments can include, or be a part of, a three-dimensional (3D) printing apparatus to perform measurements on additively manufactured objects. In some instances, a controller can be operated to measure the parameters and/or generate the images, as well as to modify parameters that impact the object being printed, such as parameters associated with the printer or a surrounding print environment. The embodiments of the present disclosure can serve as a precursor for high-throughput discovery of novel nano- and micro-architected materials, on-the-fly defect identification in advanced microscale devices, and microscopic acoustic material (e.g., metamaterial) design, for example for medical ultrasound devices.

One exemplary embodiment of a method of analyzing one or more properties of an object includes providing an object that includes a micro-scale material and irradiating the micro-scale material. The micro-scale material is irradiated using a characterization module via a laser-induced resonant acoustic spectroscopy (LIRAS) technique, which includes a pump module to excite elastic standing waves within the micro-scale material and a probe module that includes a phase-mask interferometer. The method further includes measuring the elastic standing waves with the probe module and obtaining one or more properties of the object based on the measured elastic standing waves.

Tuning can further include selecting one or more of a location on a surface of the micro-scale material that is targeted by at least one of the pump laser or the probe laser or a relative orientation of at least one of the pump laser or the probe laser to adjust a type of elastic wave that is induced within the object. The method can further include adjusting the LIRAS relative to the micro-scale material such that a location of irradiation of the micro-scale material changes between a plurality of: (i) coincident pump module and probe module excitation of a center of the micro-scale material; (ii) off-center pump module and probe module excitation of the micro-scale material with separate pump module and probe module excitation sites; or (iii) lateral excitation of the micro-scale material with separate pump module and probe module excitation sites. Adjusting the LIRAS can change the elastic standing waves measured by the probe module to include a plurality of: (i) longitudinal waves; (ii) flexural waves, or (iii) torsional waves. In some embodiments, the method can further include tuning a pump-continuous wave probe scheme of the pump laser and the probe laser.

In some embodiments, the one or more properties can be dynamic properties that include one or more of omnidirectional elastic stiffness, damping properties, or defect quantification. Obtaining one or more properties from the measured elastic standing waves can include converting the elastic standing waves to surface displacement information of the micro-scale material. The micro-scale material may not be physically contacted by a structure of an outside object where the outside object is used for purposes of obtaining the one or more properties of the object. The micro-scale material may not be deformed throughout the analysis of the one or more properties of the micro-scale material.

In some embodiments, measuring the elastic standing waves can include a measuring rate of 10⁴ measurements per about fifty seconds. The method can further include applying a thin chromium coating to the micro-scale material prior to irradiating. The micro-scale material can be a metamaterial. In some embodiments, the micro-scale material can include one or more of ceramics, polymers, glasses, metals, and composites.

In some embodiments, the method can further include repeating irradiation of the micro-scale material using one or more of the LIRAS technique or a second LIRAS technique, and measuring the elastic standing waves following the repeated irradiation.

Providing an object that includes a micro-scale material can include forming a polymeric microlattices out of a resin using at least one of a two-photon lithography technique or a two-photon polymerization technique. In some embodiments, providing an object that includes a micro-scale material can include printing the micro-scale material on a substrate that includes a glass chip.

One exemplary embodiment of an additive manufacturing system includes an additive manufacturing printer, a characterization module, and a controller. The characterization module is configured to measure one or more dynamic properties of an object being printed by the additive manufacturing printer. The characterization module includes one or more pump lasers configured to emit a pulse at the object being printed to induce an elastic standing wave that produces an elastic response within the object being printed, and one or more probe lasers configured to emit a pulse to measure the elastic response. The controller is configured to convert a vibrational signature of the one or more elastic standing waves to at least one of one or more dynamic properties or one or more wave propagation measurements of the object being printed. The dynamic properties include one or more of omnidirectional elastic stiffness, damping properties, or defect quantification. The characterization module can measure the vibrational signature of the object being printed without contacting the printed object with a structure of an outside object where the outside object is used for purposes of obtaining the dynamic properties.

The pump module can include a picosecond pump laser and the probe module comprises a continuous-wave laser. The elastic response can be a surface displacement within the object. The elastic standing wave can be one or more of a: (i) longitudinal wave; (ii) flexural wave; or (iii) torsional wave. The probe module can be configured to measure the elastic response occurs substantially in real-time with the object being printed by the additive manufacturing printer. In some embodiments, the object being printed can be a three-dimensionally (3D) printed metamaterial. The 3D printed metamaterial can include a fabricated polymeric microlattice comprising a photoresist.

The system can further include a photodiode in communication with the one or more probe lasers, the photodiode being configured to register interferometric signals corresponding to the waveforms of the surface displacement within the object.

The system can further include one or more stages that are configured to be set at a location where the object being printed is formed and configured to be moved between a printing area of the additive manufacturing system where the additive manufacturing printer deposits material to form the object being printed and a testing area of the system where the characterization module is configured to be operated to measure one or more dynamic properties of the object being printed. In some embodiments, the additive manufacturing printer can be configured to operate using at least one of the following techniques: powder bed fusion, material extrusion, material jetting, binder jetting, directed energy deposition, vat photopolymerization, sheet lamination, or hybrid.

The object being printed can include a body having a tetrakaidecahedron morphology or an octet morphology. The object being printed can include a coating configured to absorb at least a portion of the pulse to induce broadband acoustic waves. In some embodiments, the pulse can be a photoacoustic wave.

### BRIEF DESCRIPTION OF DRAWINGS

This disclosure will be more fully understood from the following detailed description taken in conjunction with the accompanying drawings, in which:

FIG. 1A is a schematic diagram of a custom laser-induced resonant acoustic spectroscopy (LIRAS) method of the present embodiments, employing a pump laser to excite acoustic waves, and a probe laser for interferometric measurements of the sample displacement;

FIG. 1B is a set of scanning electron microscope (SEM) images of metamaterial architectures of the present embodiments that are used in the LIRAS method of FIG. 1A;

FIG. 1C is a schematic illustration of pump-continuous wave probe schemes to excite longitudinal, torsional, and flexural modes in the metamaterials of FIG. 1B, accompanied by a depiction of resulting resonant modes;

FIG. 1D is a graph illustrating representative waveforms obtained from the longitudinal excitation of octet, tetrakaidecahedron, and monolithic samples of FIG. 1B;

FIG. 2 is a graph illustrating measurement-time and idle-time of LIRAS experiments of FIG. 1A to demonstrate the throughput of the LIRAS method;

FIG. 3A is schematic illustration of an example embodiment of a characterization module of the present embodiments for performing the LIRAS technique to excite longitudinal and flexural modes;

FIG. 3B is schematic illustration of an example embodiment of a characterization module of the present embodiments for performing the LIRAS technique to excite torsional modes;

FIG. 4A is a schematic illustration of an example embodiment of pillars that can be measured by the LIRAS technique of FIG. 1A;

FIG. 4B is a graph illustrating the longitudinal eigenfrequencies of the pillars of FIG. 4A following the LIRAS technique;

FIG. 5A is a schematic illustration of another example embodiment of a structure that can be measured by the LIRAS technique of FIG. 1A;

FIG. 5B is a graph illustrating eigenfrequencies measured by the LIRAS technique of FIG. 1A of the structure of FIG. 5A;

FIG. 5C is another graph illustrating eigenfrequencies measured by the LIRAS technique of FIG. 1A of the structure of FIG. 5A;

FIG. 6 is a schematic illustration of an additive manufacturing (AM) printer system that includes the characterization module of FIG. 3A to serve as a module for micrometer or millimeter-scale component characterization;

FIG. 7 is a schematic illustration of a plurality of characterization modules of FIG. 3A performing characterization of components within an assembly line; and

FIG. 8 is a schematic diagram of one exemplary embodiment of a computer system upon which the control system of the present disclosures can be built.

### DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

To the extent that the instant disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible. Likewise, while the present disclosure includes discussions of applying the systems, devices, and methods to metamaterials, a person skilled in the art will appreciate the systems, devices, and methods can be more generally applied to other materials, including but not limited to monolithic materials and/or metamaterials made of polymer(s), ceramic(s), glass(es), metal(s), aerogel(s), composite combinations of the aforementioned categories, and so forth. Additionally, a number of terms may be used throughout the disclosure interchangeably but will be understood by a person skilled in the art. By way of non-limiting example, the terms “analyze” and “measure” may be used interchangeably with one another to refer to a process of characterization performed by the systems, devices, and methods of the present embodiments to characterize a particular property or a parameter of a material being assessed by the systems, devices, and methods of the present embodiments. By way of further example, the terms “print” and “manufacture,” as well as additive manufacturing and 3D printing, as well as variations thereof commonly known to those skilled in the art, may also be used interchangeably herein.

Still further, to the extent features or steps are described as being “first” or “second,” such numerical ordering is generally arbitrary, and thus such numbering can be interchangeable. Additionally, in the present disclosure, like-numbered components of various embodiments generally have similar features when those components are of a similar nature and/or serve a similar purpose, unless otherwise noted or otherwise understood by a person skilled in the art. The present disclosure includes some illustrations and descriptions that include prototypes or bench models. A person skilled in the art will recognize how to rely upon the present disclosure to integrate the techniques, systems, devices, and methods provided for into a product in view of the present disclosures. For example, a person skilled in the art, in view of the present disclosures, including but not limited to the various schematic illustrations and related descriptions provided for herein, will be able to implement the present disclosures in and/or with respect to a commercial-ready additive manufacturing or three-dimensional printer.

The present disclosure provides for systems, devices, and methods for measuring the dynamic properties of three-dimensional (3D) metamaterials at the microscale, enabled by characterization of a non-destructive and/or non-contact optical framework that converts vibrational signatures to dynamic elastic properties and wave propagation measurements. The system can include a pulsed-laser-based mechanical characterization technique that leverages photoacoustic excitation of elastic waves within the material of interest by emitting lasers at the metamaterial in various directions and measuring a behavioral response therefrom. The pulsed-laser-based mechanical characterization technique, referred to as laser-induced resonant acoustic spectroscopy (LIRAS), can employ the vibrational response of the sample of interest to extract dynamic mechanical properties. In some embodiments, LIRAS can demonstrate a high-throughput non-contact framework that employs MHz-wave propagation signatures within a metamaterial to nondestructively extract dynamic linear properties, such as omnidirectional elastic information, damping properties, and/or defect quantification. The LIRAS technique can provide a route for accelerated data-driven discovery of materials and microdevices for dynamic applications such as protective structures, medical ultrasound, or vibration isolation. LIRAS therefore offers a solution for employing nondestructive vibrational signatures as an alternative to slower microscale contact-based approaches, enabling understanding and discovery of materials, such as metamaterials, in regimes closer to real-world applications.

In some embodiments, the analysis can be performed as a part of an additive manufacturing (AM) system in which LIRAS is in communication with a 3D printer to perform non-contact characterizations of a dynamic response of a printed part. The analysis of the samples of the present embodiments can be performed by a controller(s) or other mechanisms known to those skilled in the art, and the responsive actions can also be performed by a controller(s), including but not limited to the same controller(s) performing the analysis, by one or more users monitoring the print job, and/or an outside system that is in communication with the AM printer to adjust print parameters and/or the object being printed. In at least some instances, such adjustments can be made in real-time as a result of the set-ups enabled herein.

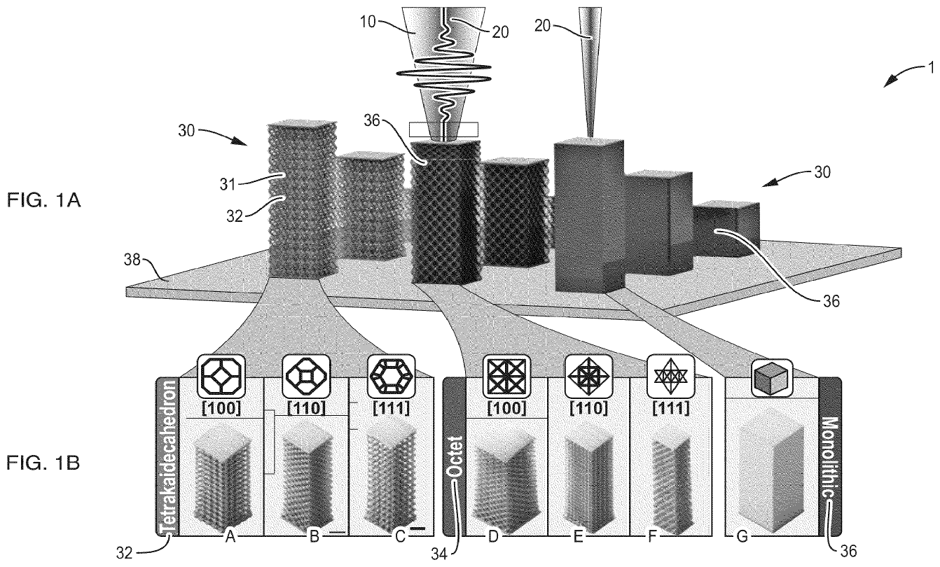

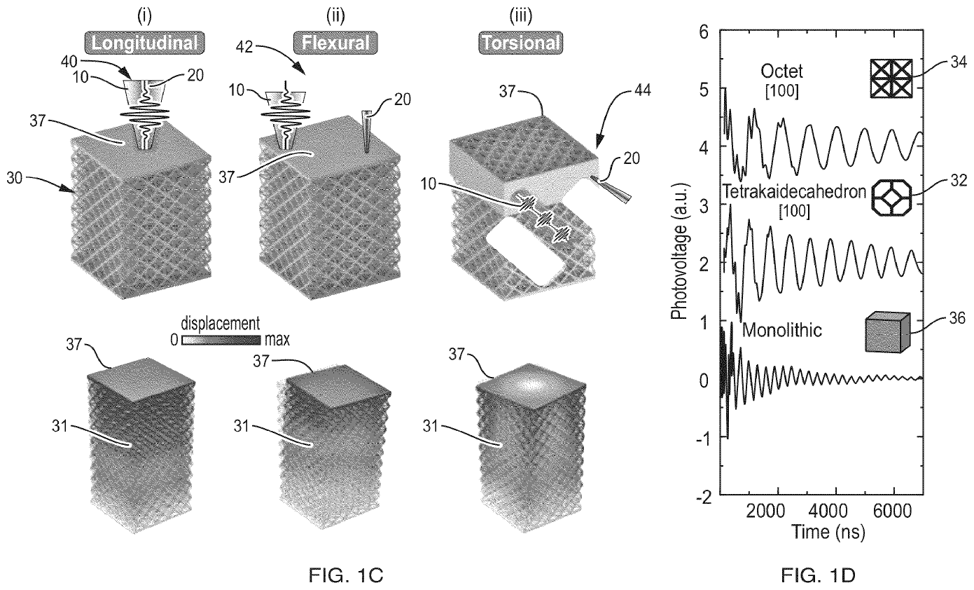

FIGS. 1A-1B illustrate one exemplary embodiment of a schematic of a LIRAS technique, method, and/or set-up 1 of the present embodiments that can cause non-contact laser-induced excitation and probing of elastic waves in metamaterials. As shown in FIG. 1A, the LIRAS technique, method, and/or set-up 1 can include a pump module or pump laser 10 and a probe module or probe laser 20, for example a continuous-wave (CW) laser, that can be applied to one or more samples, e.g., metamaterials 30, to measure properties thereof. It will be appreciated that the LIRAS technique 1 of the present embodiments is a high-throughput, non-contact alternative to classical nanoindentation measurement techniques. For example, in some embodiments, the pump module 10, e.g., a picosecond pump laser, can be applied with a thin chromium coating that can partially absorb the laser pulse of the pump module 10 and induce broadband acoustic waves. Absorption of the laser pulse can lead to sudden thermal expansion that excites broadband acoustic waves within the metamaterial 30. Due to wave reflections at sample boundaries, standing waves of specific frequency components can be formed within the samples 30, corresponding to eigenvibrations. These standing waves can be measured by the probe module 20, e.g., a phase-mask interferometer, which can allow for time-resolved nanometer-resolution measurement of the sample surface displacement induced by the acoustic waves.

The pump laser 10 and the probe laser 20 can have different structures. For example, the picosecond pump laser can use tens of μJ pulse-energy (e.g., uncompressed output of Astrella, Coherent, max. 9 mJ) to induce fast thermal expansion on the metal-coated (e.g., 50 nm thick Cr or Au/Pd) surface of metamaterials 30. The probe 20 can be a continuous-wave laser (e.g., Verdi, Coherent) that outputs a 10 mW (around 2.5 mW arrives on the sample) beam. The CW laser 20 can be the light source for a phase mask interferometer which measures the surface displacement of a sample as a function of time. The interferometric laser beam can be registered by an avalanche photodetector (e.g., c5658, Hamamatsu) with 1 GHz bandwidth and 50 kHz low-frequency cut-off.

To enable the detection of the material anisotropy, the metamaterial samples 30 can be fabricated along different lattice orientations. FIG. 1B illustrates architectures of the metamaterials 30 of FIG. 1A in greater detail. The metamaterials 30 can have a body 31 that is formed from lattices of one or more of tetrakaidecahedron 32, octet 34, and/or monolithic 36 architectures. As shown in the SEM micrographs in FIG. 1B, having a scale bar of 20 μm, each of the metamaterial architectures that can be used with the LIRAS method of the present embodiments can be further categorized based on their lattice structures, as seen by tetrakaidecahedrons 32 (A, B, C), octets 34 (D, E, F), and monolithic 36 (G). The body 31 with a flat top surface 37 can be disposed in direct contact with a substrate 38, and/or on a substrate 38, as shown and described in detail below, or via different attachment boundary conditions between the substrate 38 and the body 31.

The metamaterials 30 of the present embodiments can be nano-architected carbon materials that are fabricated in a variety of ways. For example, in some embodiments, the metamaterials form polymeric microlattices out of an IP-Dip resin using a two-photon lithography technique or two-photon polymerization technique (e.g., PPTG2, Nanoscribe GmbH). The lithography laser can be a femtosecond laser with the center wavelength at 780 nm and the maximum power of 50 mW. Tetrakaidecahedron 32 (A-C) and octet 34 (D-F) morphologies can be selected as representatives of kinematically rigid and non-rigid architectures, respectively. For example, an octet unit cell of the nominal dimension of 10 μm×10 μm×10 μm and strut diameter of 1 μm can be used as a standard building block. Out of these blocks, a tessellation of 5×5×n (variable height) unit cells can be used to construct the lattice, with n ranging, by way of non-limiting examples, from 4 to 22, to make up the rod-like metamaterial samples 30 of varying heights, as shown in FIG. 1B. These samples 30 can be fabricated with a writing speed of about 10 mm s⁻¹ and laser power of 30 mW for lattices (A-F) and 25 mW for monolithic sample G. During fabrication, the laser can be set to about 60% of its maximum power and applied to the microlattices to polymerize the lattice, though it will be appreciated that at a level of about 50% of its maximum power, the laser can be used to polymerize bulk samples or components to avoid creating cavitation bubbles.

The samples 30 can be printed on the substrate 38, which in at least some embodiments can include a glass chip coated with an indium tin oxide (ITO) thin film. The coating can facilitate better interface finding between the resin of the metamaterials 30 and the glass of the substrate 38. All samples can be developed for about 20 min in propylene glycol monomethyl ether acetate (PGMEA), followed by an approximately five (5) minute rinse in isopropanol and subsequent drying in a critical point dryer (e.g., Autosamdri 931, Tousimis). After fabrication and drying, the chips can be coated with about 50 nm of chromium (Cr) using, for example, a sputter deposition tool (e.g., Orion, AJA International Inc.), yielding a reflective surface for LIRAS excitation. Relative density of each lattice can be determined by measuring geometric feature dimensions of each unit cell via scanning electron microscopy (SEM), including unit cell size and strut dimensions, then modeling the unit cell in the SolidWorks computer program or other similar program. The volume of the unit cell can then be tabulated and divided by the unit cell bounding-box volume to obtain the relative density. In some embodiments, the IP-Dip polymer density can be about 1170 kg/m³ (e.g., Nanoscribe GmbH), and the relative density for the as-fabricated octet metamaterials can be about 17%, yielding about 199 kg/m 3 as the effective octet lattice density. The relative density of the as-fabricated tetrakaidecahedron metamaterials can be about 14%, yielding about 162 kg/m 3 as the effective tetrakaidecahedron lattice density.

The pump laser 10 and the probe laser 20 can be aimed at the metamaterials 30 in a plurality of locations to excite elastic metamaterial responses, e.g., waves, therein. That is, each of the pump-CW probe schemes shown can include a varying location of the metamaterial on which the pump laser 10 and the probe laser 20 are focused. For example, simple optical alignment of the lasers to pump and probe at different sample locations can be used to initiate the conventional impulse excitation technique of elastic waves within the metamaterials 30. FIG. 1C illustrates an exemplary schematic of pump-CW 10, 20 probe schemes to excite and/or induce three types of standing elastic waves: (i) longitudinal waves or modes; (ii) flexural waves or modes; and/or (iii) torsional waves or modes, accompanied by a depiction of resulting resonant modes (see FIG. 1D). Primary excitation of each of these waves can be achieved by tuning the pump-CW probe scheme of the lasers. For example, using the center pump-CW probe scheme 40, coincident pump-CW probe lasers 10, 20 can be aimed at the center of the sample 30, as shown in (i) of FIG. 1C, to induce a primarily longitudinal wave in the metamaterial 30. Similarly, off-center excitation 42 from the top surface 37 of the sample 30 with different pump-probe sites, as shown in (ii) of FIG. 1B, can induce a primarily flexural wave in the metamaterials 30. Lateral excitation at the top surface 37 of the sample 30 with separate pump-probe locations, as shown in (iii) of FIG. 1C, can induce a torsional wave. Displacement of each of the center pump-CW probe schemes 40, 42, 44 is shown corresponding to the excitation of waves through the samples 30. As shown, samples 30 that are subjected to the center pump-CW probe scheme 40, as in (i), and off-center excitation with different pump-probe sites 42, as in (ii), can exhibit maximum displacement closer to the top surface 37 with a decreasing gradient of displacement occurring throughout the body 31 as the body approaches the substrate 38. When samples 30 are subjected to lateral excitation at the top surface 37 of the sample 30 with separate pump-probe locations, as in (iii), a gradient of displacement can be observed, though a center of the top surface has no, or substantially no displacement. Moreover, the faces of the body 31 in (iii) exhibit less displacement than those of (i) and (ii).

Representative waveforms obtained from longitudinal excitation of octet 34, tetrakaidecahedron 32, and monolithic samples 36, are shown in FIG. 1D. These waveforms are generated following measurements performed by the probe module of the standing waves that resulted from excitation of the metamaterials 30 by the laser 10. As shown, characteristic response waveforms attenuated due to inherent vibrational decay but can last for approximately a range of 10 microseconds (μs) to about 200 μs, depending on factors such as sample type and pump scheme, and experimental calibration enabled translation from photovoltage to surface displacement.

Some non-limiting examples of properties that can be measured using these waveforms can include dynamic linear properties, such as omnidirectional elastic information, damping properties, and/or defect quantification. For example, in some embodiments, upon excitation, these microlattices can approach the limit of rod-like one-dimensional (1D)-wave propagation. That is, using these rod-like tessellations of microscopic metamaterials, up to about 94% direction, and rate-dependent dynamic stiffening at strain rates approaching about 10² s⁻¹ can be found, in addition to damping properties three times higher than their constituent materials. Moreover, frequency shifts in the vibrational response of these metamaterials can allow for characterization of invisible defects within the samples, and selective probing allows for construction of experimental elastic surfaces, previously only possible computationally.

A benefit of the LIRAS techniques provided for herein is that the application of the pump-CW 10, 20 probe schemes of the present embodiments are non-contact and non-destructive. For the purposes of the present disclosure, a non-contact scheme is a scheme in which the material can be physically contacted by a physical structure of an outside object where the outside object is used for purposes of obtaining the one or more properties of the object. That is, a non-contact scheme is one in which physical objects, such as devices, instruments, tips, and other structures as understood by one skilled in the art, do not contact the material 30 being tested. It will be appreciated that this does not preclude lights from light sources, lasers, waves, and other non-physical objects from contacting the material to perform analysis thereof.

Leveraging elastic wave propagation within the materials, the full dynamic elasticity tensor can be extracted and mechanical-wave propagation and damping properties can be characterized, with quantification of the presence of defects. As mentioned above, the LIRAS technique 1 of the present embodiments can be a high-throughput, non-contact alternative to classical nanoindentation measurement techniques, the LIRAS technique 1 offering a number of advantages. By way of example, the LIRAS technique 1 can allow for analysis of various shapes of metamaterials 30 that can otherwise be unsupported in nanoindentation. For instance, the LIRAS technique 1 can accommodate for a much wider range of sizes and shapes of metamaterials for analysis as compared to more traditional techniques, as well as dynamic regimes not accessible by classical techniques. Some additional non-limiting examples of shapes that can be analyzed with the LIRAS technique 1 of the present embodiments can include cubes, prisms, cuboids, two-dimensional shapes, and so forth.

Still another benefit of the LIRAS techniques provided for herein is that they allow for a greater variety of measurements due, at least in part, to the variability of pump-CW probe schemes that can be implemented in conjunction with the technique. For example, conventional techniques typically offer a top-down approach that do not appreciate that the approach angle of the laser with respect to the metamaterial 30 would affect the diagnostic capabilities of the analysis. Moreover, conventional techniques do not appreciate that a location along a surface at which testing is performed, e.g., location that the lasers are aimed, can affect dynamic linear properties values, such as omnidirectional elastic information, damping properties, and/or defect quantification. As discussed above, the schematic of pump-CW 10, 20 probe schemes can be used to excite and/or induce three types of elastic waves: (i) longitudinal waves; (ii) flexural waves; and (iii) torsional waves. The ability to gather data for multiple properties of the sample 30 using a single pump pulse is not contemplated by conventional techniques. This allows the present techniques to accurately diagnose properties such as, for example, shear torsion of metamaterials due, at least in part, to the shear torsion of rectangular prisms, and other non-cube shapes, differing across the various face of the object due, at least in part, to various arbitraty sample form factors. The ability to excite torsional modes in the metamaterials can allow for performance of measurements of shear torsion from these arbitraty sample form factors that cannot be gathered using conventional nanoindenters and other known techniques in the art due to the inability of nanoindentation to gather any shear measurements.

In view of the low-amplitude elastic deformation and short timescales of excitation, the LIRAS techniques disclosed can be inherently non-destructive and can allow for a repeated measurement rate of, by way of non-limiting example, 10³ s⁻¹, which surpasses existing nanomechanical characterization techniques (all contact-based) by at least about two orders of magnitude. As mentioned above, nanoindenters are nanomechanical tools that are contact-based. Primarily these nanoindenters contact the surface of the material with a sharp-tipped object that creates a crevice, crack, and/or deformation in a surface of the object, which can compromise the usability of the object in future testing to yield accurate results. In some cases, conventional techniques can result in a complete break of the object that prevents the object from being able to be used in further tests. Moreover, the need for contact can limit the amount of properties gathered by the analysis to a subset of the quasi-static regime. For example, nanoindenters can struggle with gathering dynamic measurements such as damping information, which uses the onset of vibrations on the sample. Further, high deformation rates can be unachievable due to challenges with actuation of the tip (via piezoelectric stacks or capacitive-spring mechanisms), along with undesirable ringing of load cell signals. Prior to the present disclosure, a person skilled in the art did not appreciate that these properties can be measured using non-contact forms of exposure, such as the lasers of the present embodiments. The lack of contact in the LIRAS technique 1 of the present embodiments can avoid these shortcomings by avoiding contact altogether with the metamaterial sample, thereby allowing for repeated irradiation of the samples and measurements to be taken, thereby accommodating for future testing without modifying the properties of the specimen. Moreover, the metamaterials in the LIRAS technique are able to be assessed for the full range of dynamic scale measurements. While some of these measurements can be performed with contact-based piezoelectric transducers, the accuracy, fast high-throughput, and repeatability of the LIRAS technique can be much more advantageous.

Additional uniaxial compression experiments to strain rates of up to 10² s⁻¹ on both monolithic polymer micropillars and 5×5×5 tessellations of the octet metamaterial 34 lattice structure (A) and tetrakaidecahedron metamaterial 32 (D) lattice structure can confirm the rate-dependent response observed in LIRAS measurements. Specifically, despite the different nature of conventional nanoindentation and the LIRAS technique 1, i.e., the contact-based method targets a single strain rate while a range of strain rates are accessed in the free-vibration case of the present embodiments, agreement to within 10% was observed across all sample types between the two techniques. These measurements confirmed that achieving high-rate, nanometer-scale displacements via photoacoustic excitation effectively allows for non-destructive dynamic characterization, presenting an alternative to single-measurement destructive experiments and their concomitant signal-to-noise ratio challenges.

The present embodiments can merge expertise from laser ultrasonics and metamaterial fabrication, elucidating a potential path for iterative and robust characterization of metamaterials, as well as other materials (e.g., monolithic, polymers, ceramics, glasses, metals, composites), in the dynamic regime. Moreover, the methodology of the present disclosure can potentially facilitate use of acoustic metamaterials (such as twistronics), and provide a versatile approach to expedite mechanical-property explorations.

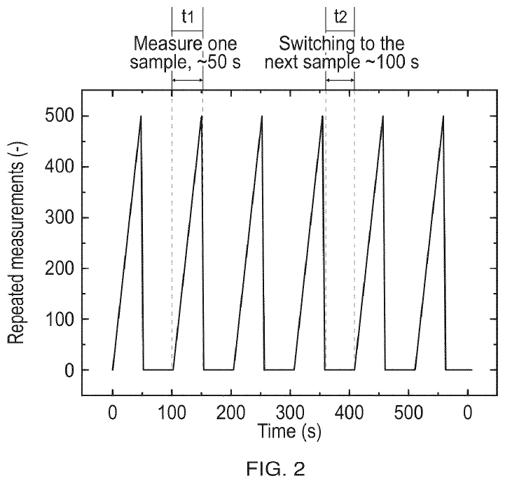

To further describe the LIRAS-measurements time estimates, additional details of the LIRAS measurement procedure can be used to validate the categorization of the provided method(s) as being high-throughput. For example, reported time used to measure one metamaterial sample can be typically between about one (1) minute to about five (5) minutes, which is a conservative upper bound for two reasons: (i) the measurement time can be dictated by a collection rate of 10⁴ measurements per sample, which get averaged into the final signal; and (ii) the average rate can be determined by the specific oscilloscope speed, which inevitably averages signals slower than the 1 kHz rate at which samples can be excited. LIRAS measurements can indeed be performed in less than one minute if fewer measurements per sample are taken (a minor compromise in signal-to-noise ratio), and a higher-end oscilloscope is used. FIG. 2 illustrates an example embodiment of measurement-time (t1) and idle-time (t2) (switching from a measured sample to the next) used to demonstrate the throughput of the LIRAS method(s) of the present embodiments. This measurement can be conducted on a pump laser with a 10 Hz repetition rate for demonstration purposes, where the read-out speed of a low-cost oscilloscope can keep up with the repetition rate of the laser. As shown, the high-throughput characterization of the samples of the present embodiments can be such that the time to measure one sample (t1) is about 50 seconds, while the time to switch to the next sample (t2) can be about 100 seconds. Therefore, the presently disclosed rate of measurement can be about 500 measurements taken over a 50 second time interval or ten measurements per second. It will be appreciated that the time to switch to the next sample (t2) can be longer than the time to measure one sample (t1) due, at least in part, to optical alignment that is performed when shifting from one sample to another.

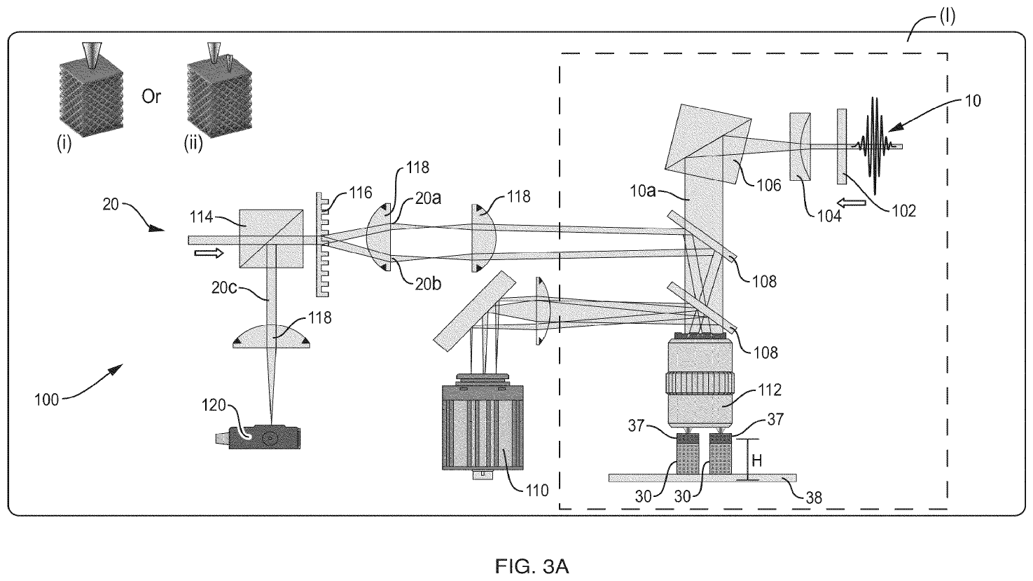

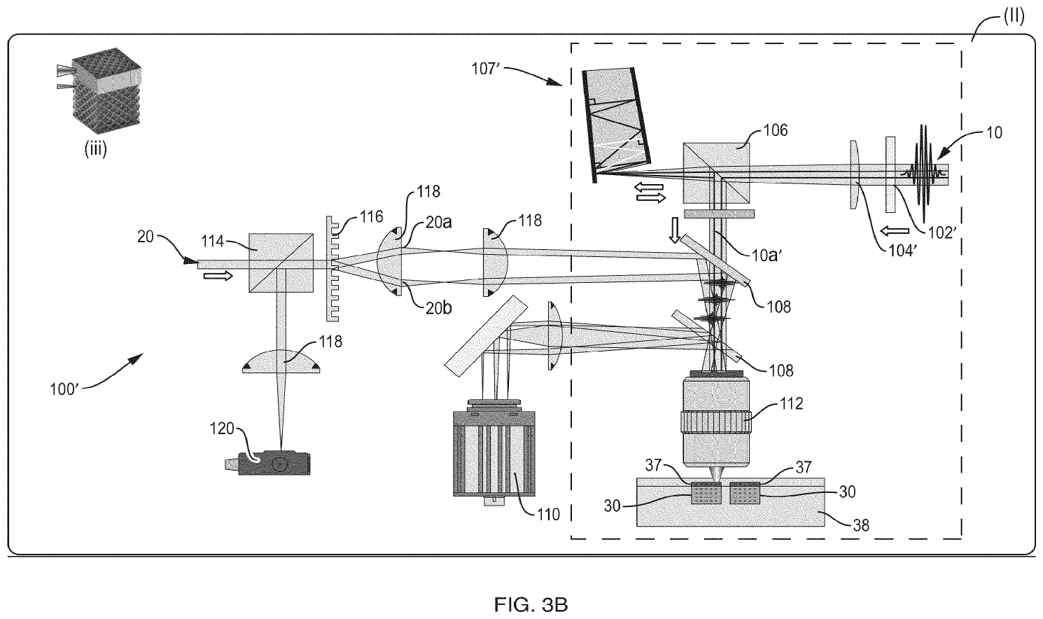

FIGS. 3A-3B provide for one exemplary embodiment of a characterization module or system 100 that employs the LIRAS technique to enable high-throughput non-destructive characterization of metamaterials at the microscale for longitudinal and flexural modes (FIG. 3A) and torsional modes (FIG. 3B). The system 100 can include a complementary metal oxide semiconductor (CMOS) camera 110 for monitoring the metamaterial samples and a photodiode 120 to register the interferometric signals corresponding to the waveforms of the sample-surface displacement. In some embodiments, the interferometric laser beam of the probe module 20 can be detected by a photodiode, which as shown is connected to an oscilloscope, as described in greater detail below. In operation, the pump laser 10 can pass a half wave plate 102 and a lens 104 to enter a polarized beam splitter 106. From the polarized beam splitter 106, a beam 10a can pass through one or more dichroic mirrors 108, an objective lens 112 to focus the laser 10 and apply the beam 10a to the top surface 37 of the metamaterials 30 as shown in FIGS. 1C and 3A. In some embodiments, the pump laser 10 can be generated from an uncompressed output of a Ti:Sapphire regenerative amplifier (e.g., Coherent Astrella) with a central wavelength of 800 nm, 1 kHz repetition rate, and a pulse duration of 300 ps. A pulse energy approximately in the range of about 20 J to about 50 J can be applied to induce sudden thermal expansion on the metal-coated (e.g., 50 nm thick Cr or Au/Pd) sample surface.

The probe laser 20 can pass through a beam splitter 114 and a phase mask interferometer 116, sometimes referred to as a phase mask, driven by a CW laser (e.g., Coherent Verdi) with 532 nm wavelength and 10 mW maximum output power, while only about 2.5 mW can be shone on the sample to avoid damage, monitored by a charge-coupled device (CCD) camera (e.g., Hamamatshu Orca C13440) (not shown). This phase-mask interferometer 116 can measure the surface displacement of a given sample as a function of time. Specifically, two CW-laser beams 20a, 20b—formed as a result of beam-splitting by the phase mask interferometer 116—can be focused on (i) a vibrating sample, and (ii) a static reference sample, respectively. The reflected laser beams from the two samples can be recombined by the same phase mask interferometer 116, and the resulting interferometric beam can be registered by an avalanche photodetector or photodiode 120 (e.g., c5658, Hamamatsu) with about 1 GHz bandwidth and about 50 kHz low-frequency cut-off to register the interferometric signal corresponding to the waveforms of the sample-surface displacement. While vibrating, the sample surface displacement u_{z}(t) can induce an optical path difference ξ=2u_{z}(t) between both arms of the interferometer, which can be translated into a change of intensity of the signal beam and a measurable change in photovoltage by the photodetector. As shown, each of the beams 20a, 20b can pass through one or more lenses 118 before arriving at the dichroic mirror 108. At the dichroic mirror 108, the pump laser and the probe laser beams 20a, 20b can pass through another dichroic mirror 108. For example, as shown, a portion of the beams 10a, 20a, 20b passes through the objective lens 112 to the metamaterials 30 in the longitudinal or flexural modes, while the reflected probe beam (recombined from 20a and 20b) from the sample, can pass through a lens 118 and arrive at the photodetector 120 for measuring the metamaterial displacement, as mentioned above. The CMOS camera 110 can also register the reflected beam 10a, 20a and 20b for monitoring purposes.

At least because the pump laser 10 repetition rate can be about 1 kHz, it can excite a resonant vibration approximately 1000 times per second in a given sample. Consequently, in some embodiments, a measurement can include a high signal-to-noise ratio attained by averaging of detected waveforms over 10,000 repeated measurements. Due to the acquisition speed in the waveform averaging mode of the oscilloscope (e.g., Tektronix TDS 7404), the actual measurement time can approximately range from about 1 minute to about 3 minutes, depending, at least in part, on the signal length and sampling rate.

The interferometric signal V(t) registered by the photodetector can be translated to the sample surface displacement u_{z}(t) by u_{z}(t)=λ/(4π) sin ⁻¹(2V/V₀) with λ=532 nm as the wavelength of the CW laser and V₀ as the operational range of the photovoltage. Note that the measurement range can be limited to a maximum surface displacement of about 66.5 nm when the interferometer can be operating at the highest sensitivity. However, that range can be extended, for example by tuning the initial phase offset of the interferometer, achieved by a horizontal translation of the phase mask interferometer 116. Because the pump laser 10 can induce not only acoustic waves, but also thermal expansion, the surface displacement of the sample 30 can show a combined effect at two different time scales. To eliminate the slow-varying thermal signal (typically s-periodicity), the displacement waveform can be fit with a polynomial function of up to fifth order and subsequently subtracted from the signal.

By systematically varying the sample heights H, particular wave numbers can be constrained, thereby enabling the experimental determination of eigenfrequencies as a function of wave numbers k. H is related to k through Eq. 1.

$$k = \frac{2 n - 1}{4 H} \qquad ( 1 )$$

with integer number n, and n=1 indicating the fundamental frequency, while n>1 indicating higher harmonics. The actual sample heights H (which are often a few percent smaller than the nominal ones) can be measured, for example, by taking SEM images, and then the corresponding wave numbers can be derived through this equation.

Varying the type of elastic wave that becomes excited can be a function of the location at which the beams 10a, 20a, 20b are delivered. For example, using the off-center pump-probe scheme 42 such as the flexural mode, instead of pumping and probing at the center, such as in the center pump-probe scheme 40, the pump laser 10 can be aimed at one corner of the metamaterial 30 and the probe laser 20 can be aimed at another corner to break the symmetry of the way the beams 10a, 20a, 20b are delivered to the sample 30. By breaking the symmetry, the flexural (bending) mode (ii) can be excited and detect waveforms, while partially suppressing the otherwise dominant longitudinal mode. Longitudinal and flexural eigenfrequencies can be extracted as a function of sample heights f (H). Since H is related to k through Eq. 1, dispersion relations f(k) can be determined.

Variations of the setup for the system 100 for exercising the LIRAS technique 1 between the longitudinal and flexural mode of FIG. 3A and the torsional mode of FIG. 3B are demarcated by the dashed boxes (I) and (II) in FIGS. 3A and 3B, respectively. For example, as shown in FIG. 3B, the system 100′ that includes the torsional mode variation of the LIRAS technique can include an alternate setup that includes the pump laser 10 passing through a half wave plate 102′ and a cylindrical lens 104′. The beam 10′ of the pump laser 10 can enter the polarized beam splitter 106, which splits rays of the beam into a cavity 107′, e.g., a FACED cavity, with each ray having a different path in the cavity 107′ and a portion that flows through another cylindrical lens 106 to a pair of dichroic mirrors 108. The beam 10′ can combine with the beams 20a, 20b of the probe laser 20 and enter the objective lens to focus the laser beams 10′, 20a, 20b and apply the beams 10′, 20a, 20b to the top surface 37 of the metamaterials 30, as shown in FIGS. 1C and 3A.

While dispersion relations obtained via the LIRAS technique 1 can provide insight into different types of elastic waves supported by these metamaterials, this information can be leveraged to determine their dynamic mechanical properties. For example, when the dispersion relation f(k) is determined, the elastic properties of the metamaterials can be extracted. Additional non-limiting examples of dynamic mechanical properties of the metamaterials that can be measured with the LIRAS technique of the present embodiments can include longitudinal bending, shear torsion, damping properties, and/or defect quantification, in a broad MHz frequency regime, among others.

In addition to the dynamic measurements using the provided LIRAS techniques of the present disclosure, classical nanomechanical compression tests can be conducted on the same metamaterial samples 30 to investigate their static properties. For example, in some embodiments, the bulk polymer can show significantly different dynamic and static Young's moduli. This observation is supported by measurements of Young's modulus of bulk polymethyl methacrylate (PMMA), which has comparable static properties as the IP-Dip polymer used to fabricate the metamaterial samples 30 of the present embodiments, which has also demonstrated strong frequency dependency. For example, the dynamic Young's modulus of PMMA in MHz regime can be nearly twice as large as in the static regime.

The IP-Dip bulk polymer of the present embodiments has a similar response. Specifically, to quantify dynamic effects on the responses of the samples of the present embodiments, quasi-static (\dot{ε}=10⁻³ s⁻¹) uniaxial compression experiments can be performed using a displacement-controlled nanoindenter (e.g., Alemnis AG) on identical samples as those tested via the LIRAS techniques of the present disclosure. Comparing the effective stiffness, E*(=∂σ/∂ε), obtained through these two techniques showed dynamic stiffening effects in all samples. From experiments on the monolithic polymer samples, a viscoelastic response in the base material with a dynamic stiffness of 4740±30 MPa can be measured, corresponding to an about 74% stiffening compared to the measured quasi-static effective Young's modulus, consistent with other dynamic compressions on this material. This stiffening response was also observed in the metamaterial samples, with an on-average stiffening of about 46% for the octets and about 82% for the tetrakaidecahedra. Despite this direction-dependent dynamic stiffening, the anisotropic response of the metamaterials remained qualitatively unchanged.

For example, in addition to enabling high-throughput linear mechanical property measurements, and the established methods (e.g., nanocompression, split-Hopkinson pressure bar, etc.) for micro-scaled mechanical testing, LIRAS frequency-spectrum analysis can provide metamaterial damping properties. Analogous to a classical damped harmonic oscillator, whose oscillation amplitude is described by u(t)=u₀e^{-βt} cos (2πf−δ), the exponential temporal decay of the LIRAS experiments from an initial amplitude u₀ at a frequency f and phase shift δ can be dictated by the decay parameter β. Using center-pump FFT spectra, a spatial attenuation coefficient α=β/c_{p,L} (units m⁻¹) can be calculated, where β scales with the half-width-half-max of the longitudinal peak, and c_{p,L}=f/|k| is phase velocity of the longitudinal waves. Calculations can show higher damping for the more compliant direction in octets 34, while the stiffer directions exhibited an average of about 30% lower damping at a frequency of about 3 MHz. In tetrakaidecahedra 32, the compliant direction can also exhibit higher damping at a given frequency than its stiffer direction. Remarkably, the octet metamaterials 32 can exhibit up to an about 3.5× increase in damping ability compared to their constituent monolithic polymer 36. Fitting spatial attenuation values to the classical frequency-dependent attenuation power law [43]α(f)=α₀f^{η} yielded a scaling exponent η=1.51 for monolithic samples, in alignment with other polymer measurements. The measurements indicate that architecture and anisotropy can tune damping properties at a wide range of ultrasonic frequencies. Both metamaterials indicate higher damping capacity in compliant directions and bending-dominated architectures, over stiff and stretching-dominated responses.

### Omnidirectional Elastic Properties

To date, established experimental methods can determine effective Young's modulus only along several highly selective crystal orientations of a material. Simulations can typically be used to fill in the gap, but lack experimental validation (especially in dynamic conditions), and fail to account for damping nor boundary effects. For example, Bloch-wave analysis on metamaterials cannot simulate structural modes, which become ineligible when the lattice is finite. The disclosed LIRAS techniques can be used to provide fully experimental elastic-tensor extraction for metamaterials under dynamic conditions. There has been a growing interest in deriving the dynamic effective elastic-tensor of metamaterials, at least because they are the input parameters for machine learning, which can help to design new metamaterials (or materials more generally). Further, determination of the dispersion relation of metamaterial (or materials more generally) can be used to guide bandgap engineering.

The LIRAS techniques of the present embodiments can be applied to micro/nanoscale materials and devices beyond the lattice metamaterials 30 discussed above. For example, in some embodiments, the technique 1, as part of the instantly disclosed system 100, can inherently characterize acoustic properties in materials—providing measurement of wave speeds and vibration attenuation. Moreover, the LIRAS techniques of the present embodiments can be applicable to materials such as bulk ceramics, glasses, metals, composites, and various polymers. It will be appreciated that as long as the laser excitation is properly transduced into a sample of interest, and the interferometry method is of sufficient sensitivity, this family of methods can be material-agnostic.

The range of metals analyzed by the LIRAS technique 1 of the present embodiments when implemented as part of the system 100 of FIGS. 3A-3B can be a function of the optical components used in the systems 100, 100′. For example, the instantly disclosed systems 100, 100′ can be particularly well-poised to measure a myriad of material types and dimensions due to, for example: (i) use of advanced pump schemes, such as the multi-pump scheme used in torsional experiments, which may ensure stronger excitation where a single pump pulse would otherwise cause damage; (ii) use of a common-path interferometer, which can be more sensitive and stable than Michelson or Mach-Zehnder interferometry, and which is applied in previous variations of laser ultrasonics, enabling sub-fringe (i.e., single-digit nanometer) resolution; and (iii) the laser power employed can be merely <0.01% of that available by the pump laser (e.g., 20 μJ out of 1 J), ensuring equivalent non-damaging excitations are possible with larger spot sizes.

In view of the above, specimens that fit under a typical commercial microscope objective can work within the instantly disclosed system 100. However, it will be appreciated that the presently disclosed systems 100, 100′ can also be correspondingly adjusted for even bigger specimens at the centimeter-scale, where we may measure a local response rather than a macroscale structural response.

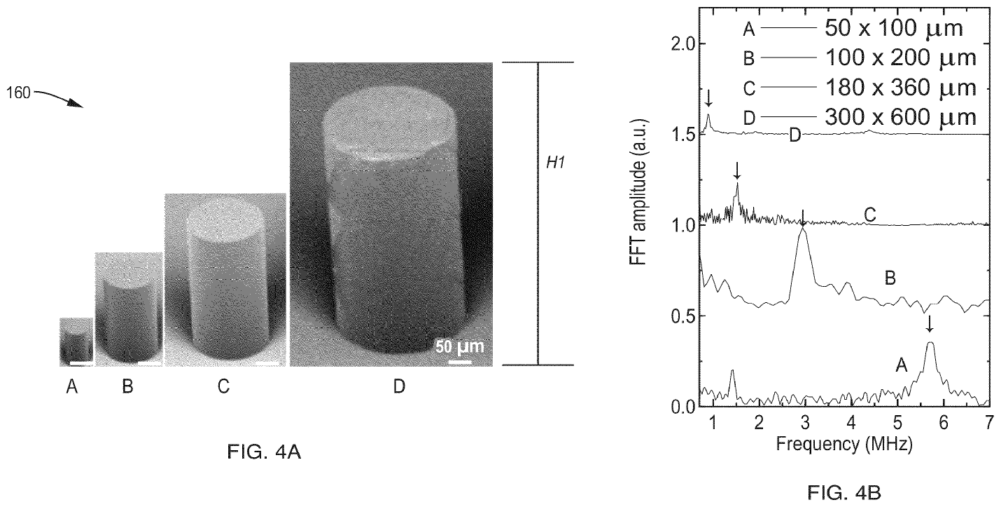

As mentioned above, the LIRAS technique 1 of the present embodiments is a high-throughput, non-contact alternative to classical nanoindentation measurement techniques. For example, the system 100 can perform equally well as compared to nanoindentation in obtaining micropillar vibrational signatures that lead to dynamic mechanical-property measurements. FIG. 4A-4B illustrate an example embodiment of sample pillars 160 to which the LIRAS technique of the present embodiments can be applied. For example, larger monolithic pillars 160 of a stiffer (IP-S) resin, as shown in FIG. 4A, corresponding to samples two orders-of-magnitude stiffer than the metamaterials 30 described above (using axial stiffness metrics k=EA/L, where E is the effective Young's modulus, A is the cross-sectional area, and L is the sample height). A slight modification in the optics and laser power can result in measurement of resonant frequencies in pillars (A)-(D), with pillar (A) being the smallest pillar and pillar (D) being the largest pillar (in both diameter and height), having the dimensions as shown in the key of FIG. 4B. As shown, the longitudinal eigenfrequencies of the pillars 160 can decrease as the sample heights H1 increase (from (A)-(D)) (the same aspect ratio for all pillars here), as expected. These measurements demonstrate the ability for LIRAS to measure material, and size, agnostic properties within the previously mentioned constraints.

### Non-Destructive Defect Identification

In some embodiments, the LIRAS technique 1 of the present embodiments can be used for identifying defects in micro-devices. Despite multiple routes to fabricate mechanical metamaterials across scales, various forms of defects emerge from fabrication or processing issues and ultimately degrade their mechanical properties. At nano-to-microscales, metamaterials can still rely on post-fabrication characterization via SEM or 3D X-ray computer tomography (XCT), with inevitable limitations of resolution and time-consuming scans. Other non-destructive techniques employing contact-based ultrasound have been widely employed in structural health monitoring, but they remain inapplicable to small length scales pertinent to metamaterials or microscale electro-mechanical devices.

Alternatively, the disclosed LIRAS techniques can be leveraged to provide high-throughput defect identification within microscopic samples, for example by measuring changes in their wave propagation response. Specifically, the center pump-probe scheme 40 can be used to identify changes in resonant frequencies as a function of defect density. In some embodiments, the LIRAS technique 1 can be performed on two typical defects in microscaled 3D-printing or MEMS: (i) bulk material insertion into microstructures; and (ii) missing struts. In both cases, resonant frequency shifts can be observed that provide sufficient resolution to determine defect densities that can be otherwise essentially impossible to identify or quantify efficiently.

For example, with respect to cases in which defects are invisible for (i) bulk material insertion into microstructures, eigenfrequencies of the longitudinal vibration can change with the amount of defects. Bulk polymer is typically stiffer than the microstructures, and the whole lattice as effective medium can become stiffer with more bulk unit cells, leading to higher eigenfrequencies. With respect to (ii) missing struts, the eigenfrequency vibrations indicate that more missing beams lead to less stiff samples, resulting in lower eigenfrequencies. In such embodiments, the flexural eigenvibrations can be well resolvable even if only the center pump-probe scheme 40 is applied. This can occur due, at least in part, to the missing beams breaking the lattice symmetry, which can lead to the bending of the samples.

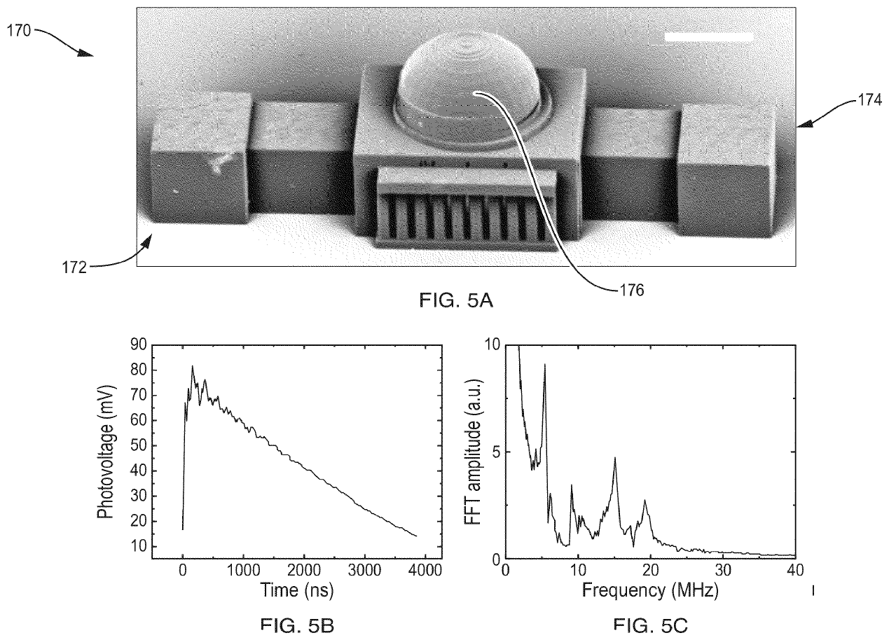

Moreover, the presently disclosed system 100 can be used to identify defects based on eigenfrequency shifts, in turn demonstrating the potential of applying this to arbitrarily shaped micro-components/devices and/or enable rapid non-destructive testing of microscopic devices or arbitrarily microscopic printed components. FIGS. 5A-5C illustrates an example embodiment of such an arbitrarily printed structure 170, and corresponding eigenvibrations thereof. As shown, FIG. 5A illustrates a building replica 170 composed of wings 172, 174 and a dome 176. Despite the irregular geometry of the structure 170, deviating from rectangles, LIRAS can still register the vibrational signatures of the specimen, as shown in FIGS. 5B and 5C.

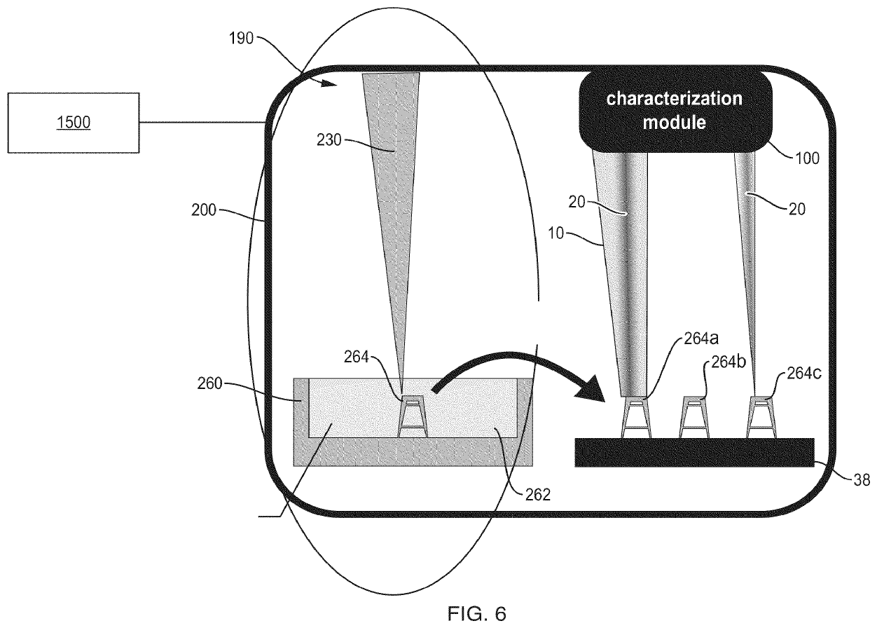

In some embodiments, the structure 170 can be 3D printed, i.e., additively manufactured, and subsequently analyzed to determine the eigenvibrations thereof. For example, as shown in FIG. 6, the system or characterization module 100 of the present embodiments can be configured to be used within an AM printer system, e.g., precision additive manufacturing system 200, for purposes of using the LIRAS technique 1 to serve as a module for micrometer or millimeter-scale component characterization within an additive manufacturing process. For example, the characterization module 100 can be used to analyze and/or measure various parameters of an object being printed, e.g., additively manufactured, by the printing features, e.g., AM printer 190, of the AM printer system 200.

The AM printer system 200 can include one or more energy sources (as shown one, a light source or laser 230), one or more mirrors (not shown), and one or more characterization modules 100 (as shown one characterization module 100 having at least one or more pump lasers 10, one or more probe lasers 20, one or more metamaterial samples or objects 264 printed by the AM printer system 200, and/or a diagnosis stage 38, though it will be appreciated that the number of characterization modules can vary, as described in greater detail below, or that characterization module 100′ can also be employed). The system 200 can also include one or more build platforms or build stages (as shown one stage 260) and one or more controllers (controller 1500 of FIG. 8) to communicate and/or operate various aspects of the system and/or the AM printer system 200 in response to analyzed parameters. In some embodiments, the stage 260 can be a vat configured to function as a powder bed or a resin vat for printing therein.

The analyzed parameters can include the object parameters, and can also include other parameters, such as print parameters and environment parameters (e.g., pressure inside a build chamber in which the printing stage is disposed). These system components can be mixed and matched as desired, with each providing various benefits as articulated herein or otherwise recognizable by a person skilled in the art. In some instances, not all of these components will be part of a single system, and instead may be provided from outside of the system. For example, the AM printer system 200 may only include the above-described components and/or include the components of the characterization module 100 discussed in FIGS. 3A-3B above, in various combinations, though alternatively, in some non-limiting instances, the stage 260 and/or a mirror may also be outside of the AM printer system 200. Various combinations of the components described herein can be selectively used in a system without departing from the spirit of the present disclosure, and most any combination is an acceptable combination for use in providing the desired analysis.

The foregoing notwithstanding, the inclusion and use of the LIRAS technique 1 provides some benefits not previously realized in AM systems, and systems that monitor AM printers, before. Further, the analysis systems provided for herein, like the system 100, can be standalone systems that can be used in conjunction with AM printers, or the systems, or components thereof, can be incorporated into AM printers directly. A person skilled in the art will recognize that some of the components illustrated in the AM printer system 200, such as the energy source 230, and the build stage 260, may be part of the AM printer, disposed externally and/or in communication with the AM printer, and thus may or may not be considered part of the AM printer system 200.

For ease of illustration, the characterization module 100 of FIG. 3A is described with respect to the AM printer system 200, but components of the AM printer are not illustrated. Accordingly, while the illustrated embodiment is described with respect to using a power bed or resin vat fusion AM printing technique, some components that can be part of such a printer are not illustrated, such as a powder chamber to house powder to be deposited, a coating roller to deposit a layer of powder on the build platform and/or on previously deposited powder, and/or a scrapper, blade, or leveling roller to aid in creating a desired and/or uniform thickness of deposited powder. A person skilled in the art will recognize how these components can be integrated in conjunction with the provided for characterization module 100, and thus it is unnecessary to include all the components of an AM printer in the illustrated figure. As described herein, some are provided for in the illustrated embodiment, and at least some such components can be part of the characterization module 100 or can be part of the AM printer.

Likewise, because powder bed fusion AM printing techniques, as well as other AM and 3D printing techniques, are known to those skilled in the art, it is unnecessary to describe how the printing technique operates in substantial detail. Rather, a person skilled in the art will understand that the printing technique generally involves loading or otherwise obtaining a print plan for the object to be printed, depositing a layer of powder onto the build platform and/or on previously deposited powder, possibly leveling that deposited layer to a desired thickness, and then operating an energy source (e.g., laser, electron beam), as shown the energy source 230 to melt the deposited layer of powder, illustrated as a resin vat 262 in view of multiple layers having been printed, selectively based on the print plan inputted into or otherwise communicated to the AM printer. In some embodiments, a moveable mirror (not shown) can be moved in any of the X, Y, and Z-directions or axes to direct the energy source 230 to the portions of the powder 262 to be fused by the laser. Alternatively, or additionally, the energy source 230 itself can be moved to help direct the laser to desired locations for fusion of the deposited powder at desired locations. While the illustrated embodiment illustrates a single energy source 230, one or more additional energy sources and/or one or more additional mirrors can be used without departing from the spirit of the present disclosure. It will further be appreciated that the number of energy sources does not have to match the number of mirrors, with a smaller or greater number of energy sources than number of mirrors being used in various embodiments.

Once the printed layer has been scanned and fused, the build platform 260 can be lowered and/or one or both of a powder chamber (not shown) and/or a coating roller (not shown) can be raised, with one or more additional layers being subsequently printed and fused based on the print plan. As shown, the layer-by-layer printing and fusing forms an object or sample 264, with unfused powder eventually being removed. A person skilled in the art will appreciate variations, additions, and/or departures from the techniques described herein that can occur without departing from the spirit of the disclosure. Once printed, the object can be passed to the characterization module 100 for measurement in-line with the LIRAS technique 1 of the present embodiments. For larger set-ups, complete spatial separation between the printing and testing areas can be achieved. This physical separation can allow for printing and testing on two different stations at the same time, thus not causing dramatic increase in print times while providing insights on material properties and microstructure. It will be appreciated that, in some embodiments, the characterization module 100 provided for herein allows for each layer to be analyzed in-situ, in real-time, directly after a layer is deposited and fused.

As shown, the diagnosis stage 38 is the location that helps define where the in-situ, real-time analysis is going to occur. The stage 260 can be part of the characterization module 100 and/or part of the AM printer system 200 while being external to the characterization module 100. Alternatively, in some embodiments, the build stage 260 can serve as the stage on which diagnosis occurs in lieu of the diagnosis stage 38 such that the AM printer system 200 includes a single stage. For example, a portion or area of the system 100 can be devoted to where the printing occurs, and another portion or area of the system 100 can be devoted to where the testing occurs. Alternatively, or additionally, it could be such that only a portion of the object being printed is tested, but as designed the present system 100 allows for an entire surface area of each layer of a printed object to be tested. Further still, in some embodiments, the energy source 230 can print onto the diagnosis stage 38 directly, with the characterization module 38 performing analysis analyzed in-situ, in real-time, directly after deposition.

In some embodiments, the stage 260 can be housed in a build chamber of the AM printer, with the build chamber being able to be environmentally controlled, such as by creating a partial vacuum or full vacuum with the build chamber as desired and/or providing an inert gas therein to protect a molten material from corroding.

The printing area and testing area can at least partially, or even completely, overlap, such as in small 3D printer set-ups. Such a system may have an increase in printing time as a result of accounting for cool-down time that may be necessary between the time the material is fused and the time the materials is to be tested by the components utilizing the LIRAS technique and/or the testing time, i.e., the amount of time it takes for the characterization module 100 to perform the measurement(s). The cool-down time may be necessary for the temperature distribution to become substantially uniform in the testing area prior to the testing occurs.

Further, before describing the in-situ, real-time analysis, it should be noted that while in the illustrated embodiment the printed object 264 can be formed using one type of powder bed fusion AM printing technique, as shown selective laser melting (SLM), other powder bed fusion AM printing techniques can be used, including but not limited to selective heat sintering (SHS), selective laser sintering (SLS), laser curing, direct metal laser sintering (DMLS), and electron beam melting (EBM). Still further, while the illustrated embodiment provides for a powder bed fusion AM printing technique, a person skilled in the art will appreciate that other AM techniques can also be used in conjunction with the present disclosures, including but not limited to material extrusion, material jetting, binder jetting, directed energy deposition, vat photopolymerization, sheet lamination, and hybrid techniques.

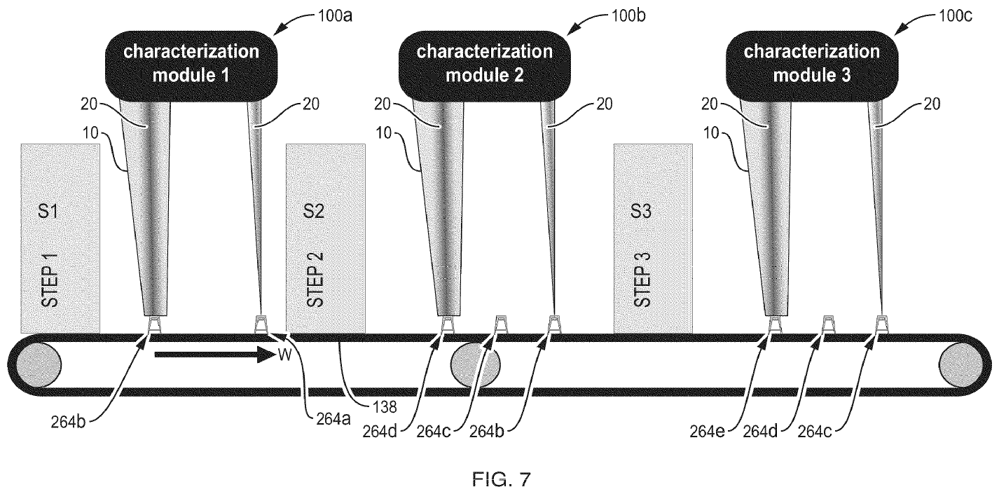

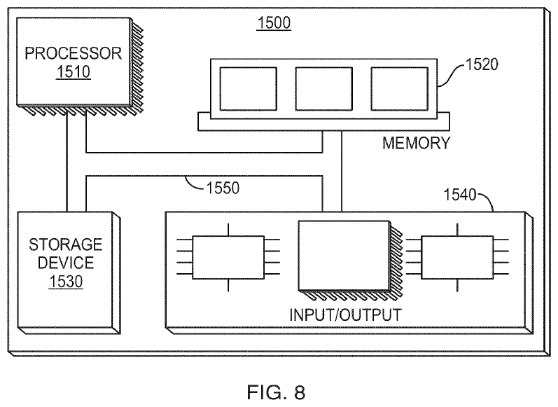

FIG. 7 illustrates use of the characterization module 100 of the present embodiments for on-the-fly characterization of components within an assembly line. For example, one or more characterization modules 100, 100′ can be arranged along an assembly line 138 to provide characterization of precision parts, e.g., printed objects 264. As shown, the characterization modules 100a, 100b, 100c can be arranged in series such that each module performs a step, though it will be appreciated that other arrangements are possible. Moreover, while three characterization modules 100a, 100b, 100c are shown, it will be appreciated that two or four or modules can be used along the assembly line 134, among other amounts of modules. The characterization modules 100a, 100b, 100c along the assembly line can be in communication with the AM printer 190 or the AM printer system 200 such that the part 264 being characterized can be recently printed by the AM printer 190, the AM printer system 200, or previously fabricated. Additionally, in some embodiments, the part 264 may not be additively manufactured, but instead may be manufactured using other techniques.

The assembly line 138 moving in the direction of the arrow W can utilize the characterization modules 100a, 100b, 100c to perform a series of steps in sequence. It will be appreciated that the characterization modules 100a, 100b, 100c can remain stationary with respect to the assembly line 138, though in some embodiments the characterization modules 100a, 100b, 100c can move with respect to the assembly line 138. As shown, in step S1, the first characterization module 100a can characterize parts 264a, 264b. In step S2, the parts can move along the assembly line 138 such that part 264b and new part 264d are characterized by the second characterization module 100b, while part 264c travels between the probe lasers 20. In step S3, the part 264c reaches the probe laser 20 and is characterized, as is new part 264e, by the third characterization module 100c, while part 264d travels between the probe lasers 20.

The characterization module 100 and/or the printing features, e.g., the AM printer 190, of the AM printer system 200 can include one or more controllers 1500 that can assist in performing the various functions associated with the system 100 and/or printer. A person skilled in the art, in view of the present disclosures, will understand how controllers, such as controller 1500, can be integrated with the system 100 and/or the AM printer to achieve desired performance results. For example, one or more controllers can be operated to carry out a print plan, operate the various components of the system 100 and/or the printer 190 (e.g., the powder chamber, the coating roller, the energy source 230, the stage 260), and/or be involved in the receipt and/or analysis of the data generated by the characterization module 100 of the AM printer system 200. A person skilled in the art will understand how a controller(s) can be operated in relation to carrying out a print plan, and thus further detail is not needed. Likewise, even though the characterization module 100 provided for herein is new at least within the context of AM, a person skilled in the art will understand how a controller(s) can be operated in relation to carrying out certain functions of the described system 100 and/or of the AM printer 190, such as the characterization module 100 or the stage 260 as provided for herein.

The controller(s) can be in communication with any or all of the components of the characterization module 100 that are generating data to be relied upon for monitoring the development of the object as it is being printed. This includes the pump laser 10, the probe laser 20, sensor(s) and/or other features used to extract the vibrational signatures, data, etc. from the printed object, and/or any components discussed with respect to FIGS. 3A-3B above. This can also include other parameters beyond the object parameters, such as the print parameters and environment parameters. The received parameters can be analyzed individually, collectively, or as a subset thereof. The analysis can be based, for example, on predetermined threshold values where if a threshold value is met (or exceeded or fallen short of), a particular action is dictated by the controller(s). For example, if is it is determined the material is too stiff, and/or has too many defects, actions can be taken to change print parameters to reduce the stiffness in that level and/or in future levels, or to change a structure thereof to reduce the number of defects. The resulting instruction from the controller(s) could be to terminate printing immediately to conserve material. The threshold value(s) can be user-defined, from known tables, from testing, and/or from a combination thereof.

A person skilled in the art, in view of the present disclosures, would understand various ways by which computer implementation can be incorporated into or otherwise used with the LIRAS technique 1 within the characterization module 100 of the present embodiments, other such systems either provided for herein or otherwise derivable from the present disclosures, as well as AM printers used in conjunction with such analysis system(s).

FIG. 8 is a block diagram of one exemplary embodiment of a computer system 1500 upon which the controller or control system of the present disclosures can be built, performed, trained, and so forth, to help control the various features of the characterization module 100, the AM printer 190, and/or the AM printer system 200 as a whole, used in conjunction with the same, as well as analyze the data received from the AM printer system 200, any component thereof, and/or an environment. For example, any devices or systems can be examples of the system 1500 described herein. For example, as described above, the controller 1500 (or a plurality of controllers) can use the data or information measured and/or generated by the characterization module 100, and other data or parameters measured or other inputted into the AM printer system 200 (e.g., print parameters, environment parameters) to generate data or information such as topographic image(s) and/or 3D-map(s) described above. Such information can be displayed to a user, such as on a display device (e.g., screen or other devices described below or otherwise known to those skilled in the art) or otherwise outputted for viewing by the user (e.g., printed, such as on paper or other medium). Additionally, or alternatively, the controller 1500 (or a plurality of controllers) can be used to modify print parameters, environment parameters, and/or other variables associated with the printer and/or the print environment in real-time in response to the parameters received by the controller(s) 1500 and/or the data or information (e.g., topographic image(s), 3D-map(s)) to adjust the print plan, and thus the printed object, in real-time.

The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, control the strength and location of the pulse laser 10 and the probe laser, communicate with the AM printer 190, communication with the characterization module, and so forth. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to metamaterial composition, measured parameters, and so forth.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a system for scheduling irrigation events. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model, as provided for at least above with respect to the cloud computing 102 of FIG. 4A and as otherwise understood by a person skilled in the art. Of course, some embodiments of the present disclosure may be implemented as a combination of both software (e.g., a computer program product) and hardware. Still other embodiments of the present disclosure are implemented as entirely hardware, or entirely software.

### EXAMPLES AND METHODS

### Fabrication of Defect-Containing Samples

The defect-containing 5×5×10 samples with bulk inclusions or missing beams can be fabricated using the same parameters and process as the octet 34 and tetrakaidecahedron 32 samples. The inclusions can be distributed inside the samples 32, 34, within the inner 3×3×9 core, such that they were not identifiable via SEM characterization. The missing-beam locations in an octahedron (or braced cubic) sample geometries were randomly assigned, resulting in a random distribution of defects within a given sample. A custom code can be employed to create missing-beam geometries with various percentages of missing struts, which can produce STL files for fabrication via two-photon lithography.

### Experimental Dispersion Relation Calculation

The LIRAS voltage-time signals (converted to displacement-time signals via interferometer calibration) can be analyzed in MATLAB to remove the thermal background by subtracting the raw data with a fifth-order polynomial fit function. The resulting waveform signal can be conditioned with a moving-average filter spanning five (5) data points. The resonant frequencies in the signal can be extracted by taking the fast Fourier transform (FFT) of the time derivative of the waveform, followed by identification of frequency peaks. The wavenumber for a given peak can be calculated as k=1/(4H) with H denoting the sample height, which was measured via laser confocal microscopy and SEM characterization. Using frequencies extracted from the FFT and calculated wavenumbers from each sample, partial experimental dispersion relations can be constructed by plotting frequency f as a function of wavenumber k. To correctly assign each vibration mode to its corresponding dispersion relation, resonant modes were selectively excited and dispersion trends were distinguished accordingly. It will be appreciated that the center-pump scheme 40 mainly induced a longitudinal mode, which can appear as a dominant peak in a frequency spectra. Correspondingly, the off-center-pump scheme 42 can lead to a dominant spectrum peak related to a bending or flexural mode. The transverse-pump scheme or torsional pump-scheme 44 excited both flexural and torsional modes. Dispersion analysis can be used to distinguish flexural 42 and torsional modes 44. At least because the fundamental mode can be the most dominant peak in the spectra, it can be the first to be determined. Subsequently, the expected third and fifth-order harmonics of the modes can be calculated by multiplying the measured fundamental frequencies by factors of three (3) and five (5). All the other measured spectrum peaks can be plotted on the same dispersion figure to compare with the higher harmonics of the modes. The modes that match the expected values were confirmed as higher harmonics. Torsional frequencies can be found to be distinctly different to those of other modes.

### LIRAS Strain Rate Estimation

Once the thermal-signal-free time-displacement curves are obtained from a LIRAS measurement, dividing by the sample height can approximate the effective strain as a function of time ε(t). Subsequently, the corresponding strain rates \dot{ε}(t) can be obtained by taking the time derivative of the strain. The characteristic strain rate for each structure can then be calculated by taking the average of the root mean square (RMS) strain rate of the tallest five (5) samples (long-wavelength limit). Since free-vibration and subsequent attenuation of the samples can encompass a range of strain rates, the bounds for these ranges can be calculated by considering the RMS strain rates for the first and last wavelengths of the signal.

### Experimental Dynamic Elastic Surface Calculation

The directional stiffness can be obtained from the longitudinal and torsional wave speeds for 5×5×n octet and tetrakaidecahedron lattices in different crystallographic orientations. The components of the dynamic compliance tensor, [symbol] ᵢⱼₖₗ can be obtained by considering their relation to the effective directional stiffness in prescribed directions. The elastic surface can be computed by calculating the directional stiffness, which for a given direction d is given by E_{d}=Ŝᵢⱼₖₗdᵢdⱼdₖdᵢ.

### Damping Quantification

The damping coefficients can be extracted by using only the longitudinal mode due to its strong signal. Using MATLAB to analyze the FFT spectra, the central frequency of the fundamental longitudinal spectral peak can be extracted in addition to its full width at half maximum (FWHM). Applying a damped harmonic oscillator model to the metamaterial, the FWHM in the frequency domain can be related to the decay parameter β(f) through β(f)=FWHM/2. The spatial attenuation coefficient α(f) can be thus derived from the measured acoustic wave velocities c_{p,L} through α(f)=β(f)/c_{p,L}. The decay parameter of a classical damped harmonic oscillator can be found by fitting the envelope of the waveform with an exponential function Ae^{-βt}. However, due, at least in part, to the multi-modal signal with multiple frequency components, the damping analysis can, in at least some embodiments, be performed only in the frequency domain using solely the longitudinal mode peak.

### Quasi-Static and Dynamic Contact-Based Uniaxial Compression Experiments

Uniaxial compressions can be performed using an Alemnis ASA nanoindenter with a 400 m-diameter diamond flat-punch tip at strain rates ranging from about 10⁻³ s⁻¹ (quasi-static) to about 10² s⁻¹. Quasi-static experiments can be performed on IP-Dip pillars (e.g., 162.8 m tall and 50 m-wide square cross-section) and 5×5×10 octet and tetrakaidecahedron A, B, and C lattices. The IP-Dip pillars and octet lattices 34 can be printed on a silicon substrate using two-photon polymerization at a laser power of 22.5 mW and 30 mW, respectively. A standard load cell with a load range of 2.5 N and a piezostack with a displacement range of 100 m can be used for compression. The tip can be operated in a displacement-controlled mode. The high-strain-rate experiments can be performed on IP-Dip pillars (diameter of 21.9 m, height of 43.3 m) and 5×5×5 octet and tetrakaidecahedron A lattices (for consistency, these samples were also compressed at a quasi-static strain rate of 10⁻³ s⁻¹). For high-rate compressions, the Alemnis high strain rate (HSR) module can be employed, comprised of a mini load cell (MLC) connected to a signal amplifier. Displacement rates from about 50 nm/s to about 5 mm/s can be applied while maintaining close to about 2×10³ points for sampling the data at all strain rates. The displacement rates can be set by assuming a constant sensitivity (the ratio of the change in displacement to the change in voltage of the piezo stack), determined through an air indent and then setting up a voltage ramp with smoothing. For strain rates between about 10⁻³ s⁻¹ and about 10⁻² s⁻¹, a maximum displacement of about 10 m can be applied. For a strain rate of about 10⁰ s⁻¹, a displacement of about 30 m can be applied and the samples can be compressed in the last approximately 15 minutes of the compression. This procedure can ensure that the indenter tip accelerated and reached a constant displacement rate before coming in contact with the sample. Similarly for strain rates above about 10⁰ s⁻¹, a total displacement of about 80 meters can be applied with the sample coming in contact in the last approximately 40% of the displacement range. The effective stiffness of the samples can be measured by calculating the slope of a least-squares linear fit to the linear loading region of the stress-strain data. The strain range for the linear fit can be restricted to about 3% strain—well within the yield point of the samples. The strain rate for the samples can be determined by measuring the total change in strain over the range of the linear fit for the stiffness and dividing that by the time taken for the change in strain. These can all be found to be within about 5% of the strain rate set for each study.

### Dynamic Explicit Simulations

Dynamic explicit simulations in ABAQUS/Explicit on an octet 34 and tetrakaidecahedron 32 unit cells with unit cell size of about 7.5 mm and relative densities of about 14% and about 17%, respectively, can be conducted. The unit cells can be meshed with, for example, C3D10M elements. The compression can be enforced with top and bottom planes tied and coupled kinematically to the top and bottom of the unit cell, respectively. The top plate can be set to compress such that a maximum 5% engineering strain was enforced at a 60 s⁻¹ strain rate with general contact properties, and an encase boundary condition for all degrees of freedom on the bottom plate. Material properties can be set such that Young's modulus of the constituent material was 2.7 GPa, density was 1,200 kg/m 3, and Poisson's ratio was 0.49.

### Eigenfrequency Analysis

Eigenfrequency simulations using the solid mechanics module in COMSOL can be conducted. As in the experiments, the bottom of each metamaterial sample can be fixed while all other parts were free to vibrate. The modeled geometry can reflect measured values of fabricated samples, with octet unit cell sizes of about nine (9) meters and strut radius of about 0.58 meters. The models can output the eigenfrequency f corresponding to each vibration mode for different sample heights, i.e., different wavenumbers k. Thereby, a simulated acoustic dispersion relation f(k) can be constructed for finite lattice tessellations of a cross-section of 5×5 unit cells in x and y directions with varying numbers of unit cells in the z direction. Monolithic samples can also be simulated with a similar aspect ratios, with a fixed cross-section of about 50 meters by about 50 meters with different heights such that a rod-wave approximation can be achieved. At least because different strain-rate compressions of monolithic samples can confirm a rate-dependent stiffness of the IP-Dip polymer, the scaling can be determined to be E*=4.216\dot{ε}^{0.0445} GPa.

### Bloch-Wave Analysis

In addition to the eigenfrequency simulation, Bloch-wave analysis can be applied within a finite element method framework to obtain a dispersion relation for octet lattices. Bloch-wave analysis can be simulated with experimental geometric values of octet unit cell size of about nine (9) meters, elliptical strut width of about 0.9 meters, elliptical strut height of about 1.96 meters, and material properties of Young's modulus of 4.522 GPa (corresponding to strain rate of 4.84 l/s), Poisson's ratio of 0.49, and density of 1170 kg/m 3. Floquet-Bloch periodic boundary conditions can be used in the COMSOL Solid Mechanics module, using symmetric fine physics-controlled mesh. The first three modes can be extracted corresponding to the lowest longitudinal and two transverse waves of the lattice structure and a best fit can be calculated using least-squares regression to extract the longitudinal and shear wave velocities, which can be used to populate the stiffness tensor. The Young's modulus and shear modulus can be obtained from the compliance tensor. Volume-averaged modal displacement can be used along principal directions to identify the mode shapes.

### Static Homogenization

To obtain the directional stiffness, computational homogenization for the octet and tetrakaidecahedron morphologies can be performed on ABAQUS/Standard (Simulia). Octet 34 and tetrakaidecahedron 32 unit cells can be built using the ABAQUS CAD module and meshed with quadratic tetrahedral (C3D10) elements with full integration. A Young's Modulus of 2.7 GPa and a Poisson's ratio of 0.49 can be used for the simulations. A mesh-convergence study can be performed to give a final mesh size of 38,660 elements and 152,682 elements for the octet and tetrakaidecahedron unit cell meshes, respectively. Periodic Boundary Conditions (PBC) can be applied such that the relative displacement between opposite faces can be constrained and an average strain can be imposed on the unit cell. Linear perturbation can be performed on the unit cells for six linearly independent strain vectors. The corresponding stresses for the applied strains were obtained and the compliance tensor [symbol] can be constructed from these.

Examples of the above-described embodiments can include the following:
1. A method of analyzing one or more properties of an object, comprising:
   providing an object that includes a micro-scale material;
   irradiating the micro-scale material using a characterization module via a laser-induced resonant acoustic spectroscopy (LIRAS) technique, which includes:
      a pump module to excite elastic standing waves within the micro-scale material; and
      a probe module that includes a phase-mask interferometer;
measuring the elastic standing waves with the probe module; and
obtaining one or more properties of the object based on the measured elastic standing waves.
2. The method of claim 1, wherein tuning comprises selecting one or more of a location on a surface of the micro-scale material that is targeted by at least one of the pump laser or the probe laser or a relative orientation of at least one of the pump laser or the probe laser to adjust a type of elastic wave that is induced within the object.
3. The method of claim 2, further comprising adjusting the LIRAS relative to the micro-scale material such that a location of irradiation of the micro-scale material changes between a plurality of: (i) coincident pump module and probe module excitation of a center of the micro-scale material; (ii) off-center pump module and probe module excitation of the micro-scale material with separate pump module and probe module excitation sites; or (iii) lateral excitation of the micro-scale material with separate pump module and probe module excitation sites.
4. The method of claim 3, wherein adjusting the LIRAS changes the elastic standing waves measured by the probe module to include a plurality of: (i) longitudinal waves; (ii) flexural waves, or (iii) torsional waves.
5. The method of any of claims 1 to 4, wherein the one or more properties further comprise dynamic properties that include one or more of omnidirectional elastic stiffness, damping properties, or defect quantification.
6. The method of any of claims 1 to 5, wherein obtaining one or more properties from the measured elastic standing waves comprises converting the elastic standing waves to surface displacement information of the micro-scale material.
7. The method of any of claims 1 to 6, further comprising applying a thin chromium coating to the micro-scale material prior to irradiating.
8 The method of any of claims 1 to 7, wherein the micro-scale material is not physically contacted by a structure of an outside object where the outside object is used for purposes of obtaining the one or more properties of the object.
9. The method of any of claims 1 to 8, wherein measuring the elastic standing waves comprises a measuring rate of 104 measurements per about fifty seconds.
10. The method of any of claims 1 to 9, wherein the micro-scale material is not deformed throughout the analysis of the one or more properties of the micro-scale material.
11. The method of any of claims 1 to 10, further comprising tuning a pump-continuous wave probe scheme of the pump laser and the probe laser.
12. The method of any of claims 1 to 11, further comprising repeating irradiation of the micro-scale material using one or more of the LIRAS technique or a second LIRAS technique, and measuring the elastic standing waves following the repeated irradiation.
13. The method of any of claims 1 to 12, wherein providing an object that includes a micro-scale material comprises forming a polymeric microlattices out of a resin using at least one of a two-photon lithography technique or a two-photon polymerization technique.
14. The method of any of claims 1 to 13, wherein providing an object that includes a micro-scale material comprises printing the micro-scale material on a substrate that includes a glass chip.
15. The method of any of claims 1 to 14, wherein the micro-scale material is a metamaterial.
16. The method of any of claims 1 to 15, wherein the micro-scale material includes one or more of ceramics, polymers, glasses, metals, and composites.
17. An additive manufacturing system, comprising:
   an additive manufacturing printer;
   a characterization module configured to measure one or more dynamic properties of an object being printed by the additive manufacturing printer, the characterization module having:
      one or more pump lasers configured to emit a pulse at the object being printed to induce an elastic standing wave that produces an elastic response within the object being printed; and
      one or more probe lasers configured to emit a pulse to measure the elastic response; and
   a controller configured to convert a vibrational signature of the one or more elastic standing waves to at least one of one or more dynamic properties or one or more wave propagation measurements of the object being printed;
   wherein the dynamic properties include one or more of omnidirectional elastic stiffness, damping properties, or defect quantification.
18. The system of claim 17, wherein the pump module comprises a picosecond pump laser and the probe module comprises a continuous-wave laser.
19. The system of claim 17 or claim 18, wherein the elastic response is a surface displacement within the object.
20. The system of claim 19, further comprising a photodiode in communication with the one or more probe lasers, the photodiode being configured to register interferometric signals corresponding to the waveforms of the surface displacement within the object.
21. The system of any of claims 17 to 20, wherein the elastic standing wave is one or more of a: (i) longitudinal wave; (ii) flexural wave; or (iii) torsional wave.
22. The system of any of claims 17 to 21, wherein the probe module is configured to measure the elastic response occurs substantially in real-time with the object being printed by the additive manufacturing printer.
23. The system of any of claims 17 to 22, wherein the object being printed is a three-dimensionally (3D) printed metamaterial.
24. The system of claim 23, wherein the 3D printed metamaterial includes a fabricated polymeric microlattice comprising a photoresist.
25. The system of any of claims 17 to 24, wherein the characterization module measures the vibrational signature of the object being printed without contacting the printed object with a structure of an outside object where the outside object is used for purposes of obtaining the dynamic properties.
26. The system of any of claims 17 to 25, further comprising one or more stages that are configured to be set at a location where the object being printed is formed and configured to be moved between a printing area of the additive manufacturing system where the additive manufacturing printer deposits material to form the object being printed and a testing area of the system where the characterization module is configured to be operated to measure one or more dynamic properties of the object being printed.
27. The system of any of claims 17 to 26, wherein the additive manufacturing printer is configured to operate using at least one of the following techniques: powder bed fusion, material extrusion, material jetting, binder jetting, directed energy deposition, vat photopolymerization, sheet lamination, or hybrid.
28. The system of any of claims 17 to 27, wherein the object being printed comprises a body having a tetrakaidecahedron morphology or an octet morphology.
29. The system of any of claims 17 to 28, wherein the object being printed further comprises a coating configured to absorb at least a portion of the pulse to induce broadband acoustic waves.
30. The system of any of claims 17 to 29, wherein the pulse is a photoacoustic wave.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

We claim:

1. A method of analyzing one or more properties of an object, comprising:
providing an object that includes a micro-scale material;
irradiating the micro-scale material using a characterization module via a laser-induced resonant acoustic spectroscopy (LIRAS) technique, which includes:
a pump module to excite elastic standing waves within the micro-scale material; and
a probe module that includes a phase-mask interferometer;
measuring the elastic standing waves with the probe module; and
obtaining one or more properties of the object based on the measured elastic standing waves.

2. The method of claim 1, wherein tuning comprises selecting one or more of a location on a surface of the micro-scale material that is targeted by at least one of the pump laser or the probe laser or a relative orientation of at least one of the pump laser or the probe laser to adjust a type of elastic wave that is induced within the object.

3. The method of claim 2, further comprising adjusting the LIRAS relative to the micro-scale material such that a location of irradiation of the micro-scale material changes between a plurality of: (i) coincident pump module and probe module excitation of a center of the micro-scale material; (ii) off-center pump module and probe module excitation of the micro-scale material with separate pump module and probe module excitation sites; or (iii) lateral excitation of the micro-scale material with separate pump module and probe module excitation sites.

4. The method of claim 3, wherein adjusting the LIRAS changes the elastic standing waves measured by the probe module to include a plurality of: (i) longitudinal waves; (ii) flexural waves, or (iii) torsional waves.

5. The method of claim 1, wherein the one or more properties further comprise dynamic properties that include one or more of omnidirectional elastic stiffness, damping properties, or defect quantification.

6. The method of claim 1, wherein obtaining one or more properties from the measured elastic standing waves comprises converting the elastic standing waves to surface displacement information of the micro-scale material.

7. The method of claim 1, further comprising applying a thin chromium coating to the micro-scale material prior to irradiating.

8. The method of claim 1, wherein the micro-scale material is not physically contacted by a structure of an outside object where the outside object is used for purposes of obtaining the one or more properties of the object.

9. The method of claim 1, further comprising tuning a pump-continuous wave probe scheme of the pump laser and the probe laser.

10. The method of claim 1, further comprising repeating irradiation of the micro-scale material using one or more of the LIRAS technique or a second LIRAS technique, and measuring the elastic standing waves following the repeated irradiation.

11. The method of claim 1, wherein providing an object that includes a micro-scale material comprises forming a polymeric microlattices out of a resin using at least one of a two-photon lithography technique or a two-photon polymerization technique.

12. An additive manufacturing system, comprising:
an additive manufacturing printer;
a characterization module configured to measure one or more dynamic properties of an object being printed by the additive manufacturing printer, the characterization module having:
one or more pump lasers configured to emit a pulse at the object being printed to induce an elastic standing wave that produces an elastic response within the object being printed; and
one or more probe lasers configured to emit a pulse to measure the elastic response; and
a controller configured to convert a vibrational signature of the one or more elastic standing waves to at least one of one or more dynamic properties or one or more wave propagation measurements of the object being printed;
wherein the dynamic properties include one or more of omnidirectional elastic stiffness, damping properties, or defect quantification.

13. The system of claim 12, wherein the pump module comprises a picosecond pump laser and the probe module comprises a continuous-wave laser.

14. The system of claim 12, wherein the elastic response is a surface displacement within the object.

15. The system of claim 12, further comprising a photodiode in communication with the one or more probe lasers, the photodiode being configured to register interferometric signals corresponding to the waveforms of the surface displacement within the object.

16. The system of claim 12, wherein the elastic standing wave is one or more of a: (i) longitudinal wave; (ii) flexural wave; or (iii) torsional wave.

17. The system of claim 12, wherein the probe module is configured to measure the elastic response occurs substantially in real-time with the object being printed by the additive manufacturing printer.

18. The system of claim 12, wherein the object being printed is a three-dimensionally (3D) printed metamaterial.

19. The system of claim 12, wherein the characterization module measures the vibrational signature of the object being printed without contacting the printed object with a structure of an outside object where the outside object is used for purposes of obtaining the dynamic properties.

20. The system of claim 12, wherein the object being printed comprises a body having a tetrakaidecahedron morphology or an octet morphology.
